(19) United States
(12) Patent Application Publication
(10) Pub. No.: US 2015/0011787 A1
(43) Pub. Date: Jan. 8, 2015

(54) PROCESS FOR PREPARING ORGANIC-INORGANIC HYBRID SILICATES AND METAL-SILICATES WITH AN ORDERED STRUCTURE AND NEW HYBRID SILICATES AND METAL-SILICATES

(71) Applicant: Eni S.p.A., Roma (IT)

(72) Inventors: Giuseppe Bellussi, Piacenza (IT); Angela Carati, San Giuliano Milanese (IT); Roberto Millini, Cerro al Lambro (IT); Caterina Rizzo, San Donato Milanese (IT); Stefano Zanardi, Novara (IT)

(73) Assignee: Eni S.p.A., Roma (IT)

(21) Appl. No.: 14/368,918

(22) PCT Filed: Dec. 21, 2012
(86) PCT No.: PCT/EP2012/076748

§ 371 Date: Jun. 26, 2014

(30) Foreign Application Priority Data
Dec. 30, 2011 (IT) MI2011A002449

(51) Int. Cl. C07F 7/18

(52) U.S. Cl. CPC C07F 7/1836
USPC 556/435

(57) ABSTRACT

The present invention relates to a process for the preparation of organic-inorganic hybrid silicates and metal-silicates of the ECS type which uses as starting material the corresponding disilanes: said process is characterized by the presence of boric acid in the reagent mixture. With the process of the invention, ECS silicates and metal-silicates are obtained, characterized by an X-Ray diffractogram with reflections exclusively at angular values higher than 4.0° of 2Θ, and characterized by an ordered structure which contains: —structural units having formula (a), wherein R is an organic group: —boron—one or more elements T, different from boron, selected from groups IIIB, NB, VB, and transition metals, with a molar ratio Si/(Si+T) in said structure greater than 0.3 and lower than 1, wherein Si is the silicon contained in the structural unit having formula (a). The silicates and metal-silicates so obtained, containing both boron and at least one element T, are new. The process also allows new crystalline phases called ECS-13 and ECS-14 to be prepared.

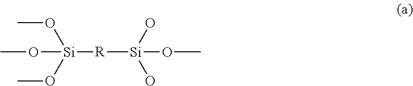

The present invention relates to a process for the preparation of organic-inorganic hybrid silicates and metal-silicates of the ECS type starting from the corresponding disilanes: said process is characterized by the presence of boric acid in the reagent mixture and allows the crystallization kinetics to be increased, also improving the crystallinity and purity of the ECS-type products obtained. The silicates and metal-silicates thus prepared, containing both boron and one or more elements T different from boron, selected from the elements belonging to groups III B, IV B, V B, and transition metals, are new, as also some particular crystalline phases called ECS-13 and ECS-14.

Silicates and metal silicates are a group of compounds which can produce two- or three-dimensional crystalline structures, compact or porous (zeolites), lamellar (micas and clays) or linear. Zeolites and clays have been of great relevance in the evolution of catalytic processes and in the separation of mixtures of different molecules. Their properties are correlated to the geometry of the crystalline structure and with the chemical composition, which determines their acid and polar characteristics. Zeolites, in particular, are crystalline-porous solids having a structure consisting of a three dimensional lattice of tetrahedra T04 connected with each other by means of the oxygen atoms, wherein T is a tri- or tetravalent tetrahedral atom, for example Si or Al. The substitution of Si or Al with other elements, such as Ge, Ti, P, B, Ga and Fe has allowed the physico-chemical properties of the materials to be modified, obtaining products having new properties, used as catalysts or molecular sieves.

The possibility of modifying the properties of crystalline-porous silicates and metal-silicates in general and zeolites in particular through the incorporation of organic groups in the framework is a theme which has been the centre of attention for some time. The incorporation of organic groups, in fact, gives the possibility of associating functional groups with the silicate or metal-silicate framework, capable of giving the material properties (for example, catalytic, optical, electronic) which could otherwise not be obtained in the purely inorganic system. Furthermore, the organic groups can modify the hydrophobicity/hydrophilicity characteristics of the material with positive consequences on the behaviour of the same in catalytic and absorption processes of organic molecules. The first attempts at modifying preformed zeolitic materials through the anchorage of organosilane compounds having general formula (EtO)₃Si—R (wherein R is an organic group capable of complexing transition metals, such as Rh) go back to the first half of the 1990s', by applying what is normally effected for the functionalization of amorphous silica or amorphous materials with an ordered mesoporosity (for example MCM-41) for gaschromatographic applications or in catalysis. In reality, as the anchorage requires a high concentration of silanol groups (Si—OH), the reaction was not successful in the case of zeolites as this condition can only be found in correspondence with intercrystalline porosity (A. Corma, M. Iglesias, C. del Pino, F. Sanchez, J. Chem. Soc., Chem. Commun. 1991, 1253; F. Sanchez, M. Iglesias, A. Corma, C. del Pino, J. Mol. Catal. 70, 369 (1991); A. Carmona, A. Corma, M. Iglesias, A. San Jose, F. Sanchez, J. Organometal. Chem. 492, 11 (1995)). Positive results were obtained, viceversa, through the direct synthesis of zeolites effected by partially substituting the conventional silica source (tetraethylorthosilicate, TEOS) with organosilane compounds. In this way, the group (—O)₃Si is incorporated in the zeolitic framework, whereas the organic group is situated inside the zeolitic porous system (C. W. Jones, K. Tsuji, M. E. Davis, Nature 393, 52 (1998); C. W. Jones, K. Tsuji, M. E. Davis, Microporous Mesoporous Mater. 29, 339 (1999); C. W. Jones, K. Tsuji, M. E. Davis, Microporous Mesoporous Mater. 33, 223 (1999); C. W. Jones, K. Tsuji, M. E. Davis, Microporous Mesoporous Mater. 42, 21 (2001)). The great disadvantage of this synthesis process is that it can be exclusively applied to zeolites synthesized in the purely inorganic system (e.g. zeolites A, X, Y) or those (e.g. Beta zeolite) from which the organic additive used for their crystallization can be chemically extracted, without any thermal treatment which would otherwise also cause the destruction of the anchored organic group. More recently, attempts have been made to incorporate simple organic groups in the zeolitic framework, using disilane compounds of the type (RO)₃Si—CH₂—SI(OR)₃ or (RO)₃Si—CH₂CH₂—Si(OR)₃, possibly associated with a second conventional silica source (e.g. TEOS). Positive results have been described by various authors especially in the case of the methylene group (—CH₂—), whose incorporation in the zeolitic framework can be considered as the isomorphous substitution of part of the —O— bridges. In particular, Yamamoto et al. have described the synthesis of materials called ZOL (Zeolites with Organic groups as Lattice) having a structure of the MFI, LTA and Beta type (K. Yamamoto, Y. Nohara, Y. Domon, Y. Takahashi, Y. Sakata, J. Plévert, T. Tatsumi, Chem. Mater. 17, 3913 (2005); K. Yamamoto, T. Tatsumi, Chem. Mater. 20, 972 (2008)). Hybrid zeolites with a structure of the ITQ-21, MFI and Beta type were subsequently described by Diaz et al. (U. Dìaz, J. A. Vidal-Moya, A. Corma, Microporous Mesoporous Mater. 93, 180 (2006)), whereas analogous materials with a structure of the FAU type were prepared by Su et al. (B. L. Su, M. Roussel, K. Vause, X. Y. Yang, F. Gilles, L. Shi, E. Leonova, M. Edén, X. Zou, Microporous Mesoporous Mater. 105, 49 (2007)). There are doubts however as to the actual possibility of obtaining hybrid structures, none of the analytical techniques used is, in fact, able to confirm with certainty the incorporation of the methylene group in the zeolitic framework, as it cannot be distinguished from an analogous group present in the amorphous phase which always accompanies the products, even if present in a negligible quantity (a few percentage units). What is certain, however, is that it is possible to produce structured materials through the condensation of disilane molecules, without there being hydrolysis of the Si—C bond. This has been demonstrated by Inagaki et al. with the synthesis of a material called PMO (Periodic Mesoporous Organosilica) (S. Inagaki, S. Guan, T. Ohsuna, O. Terasaki, Nature 416, 304 (2002)). This was obtained by treating a reaction mixture containing 1,4-bis-(triethoxysilyl)benzene (BTEB), octadecyltrimethylammonium chloride as surfactant, NaOH and water, under hydrothermal conditions at temperatures close to 100° C. The solid thus obtained is characterized by a system of mesopores with regular dimensions organized according to a regular two-dimensional hexagonal pattern, analogous to that found in the well-known alumino-silicates or silicons called MCM-41. Unlike these, characterized by completely amorphous walls, PMO shows a periodicity of 7.6 Å along the direction of the channels, an interplanar distance perfectly aligned with the dimensions of the group [O₃Si—C₆H₄—SiO₃]. This, and other analogous materials subsequently obtained using disilanes with different organic groups, have demonstrated the possibility of preparing pseudo-ordered structures, obtained by condensation of disilanes under such conditions as to render the Si—C hydrolysis extremely slow if not completely absent.

In particular, WO 2008/017513 describes a new group of materials called ECS (Eni Carbon Silicates). These materials, characterized by a three-dimensional crystalline structure in which the disilane is integrally incorporated, were obtained by the hydrothermal treatment, at relatively low temperatures and lengthy times, of a reaction mixture containing disilane, NaAlO₂, NaOH and/or KOH and H₂O. The demonstration of the nature of these materials was obtained with the resolution of the crystalline structure of two of these: ECS-2 (G. Bellussi, A. Carati, E. Di Paola, R. Millini, W. O. Parker Jr., C. Rizzo, S. Zanardi, Microporous Mesoporous Mater. 113, 252 (2008)) and ECS-3 (S. Zanardi, E. Montanari, E. Di Paola, R. Millini, G. Bellussi, A. Carati, C. Rizzo, M. Gemmi, E. Mugnaioli, U. Kolb, Proc. 16th Int. Zeolite Conf., Sorrento, Jul. 4-9, 2010).

These ECS metal-silicates are characterized by an X-ray diffractogram with reflections exclusively at angular values higher than 4.0° of 2θ, preferably exclusively at angular values higher than 4.7° of 2θ, and characterized by an ordered structure which contains structural units having formula (a), wherein R is an organic group:

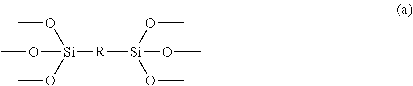

and which possibly contains one or more elements T selected from elements belonging to groups IIIB, IVB, VB, and transition metals, with a molar ratio Si/(Si+T) in said structure higher than 0.3 and lower than or equal to 1, wherein Si is the silicon contained in the structural unit having formula (a).

The process for preparing the hybrid silicates and metal-silicates described in WO 2008/017513 comprises:
1) adding a disilane having formula (c) to an aqueous mixture containing at least one hydroxide of at least one metal Me selected from alkaline and/or alkaline-earth metals, and possibly one or more sources of one or more elements T selected from elements belonging to groups IIIB, IVB, VB, and transition metals,
2) maintaining the mixture under hydrothermal conditions, at autogenous pressure, for a time sufficient for forming a solid material,
3) recovering the solid and drying it, wherein formula (c) of the disilane used in step (1) is the following:

X₃Si—R—SiX₃ (C)

wherein R is an organic group and X is a substituent which can be hydrolyzed.

Various factors influence this preparation, for example competition between the condensation reaction of the disilane molecules and the hydroysis of the Si—C bonds. The reaction conditions must therefore selected in order to favour the first reaction with respect to the second. Above all, the choice of temperature is important:
excessively low temperatures are unfavourable for the hydrolysis, but also slow down the condensation reaction jeopardizing the crystallization, in particular of some of the ECS phases;
excessively high temperatures considerably accelerate the hydrolysis reaction of the Si—C bond and therefore favour the crystallization of known zeolitic phases, which can therefore become the prevalent product.

The Applicant has now found that by adding boric acid in the first step of the preparation, the reaction kinetics is significantly increased and ECS silicates and metal-silicates are obtained with an improved crystallinity and purity. In particular, ECS are obtained, containing boron in a mixture with one or more elements T different from boron, selected from elements of groups IIIB, IVB, VB, and transition metals, and among these, also new ECS phases, i.e. new ECS characterized by the relative X-ray diffractograms.

An object of the present invention therefore relates to a process for the preparation of organic-inorganic hybrid silicates and metal-silicates of the ECS type, which comprises:
1) adding a disilane having formula (c)

X₃Si—R—SiX₃ (C)
wherein R is an organic group and X is a substituent which can be hydrolized, to an aqueous mixture containing boric acid, at least one hydroxide of at least one metal Me selected from alkaline and/or alkaline-earth metals, and one or more sources of one or more elements T, different from boron, selected from elements belonging to groups IIIB (group 13 IUPAC), IVB (group 1 IUPAC), VB (group 15 IUPAC), and transition metals,
2) maintaining the mixture under hydrothermal conditions, at autogenous pressure, for a time sufficient for forming a solid material,
3) recovering the solid and drying it.

The ECS organic-inorganic hybrid silicates and metal-silicates that can be obtained with the process of the present invention are characterized by an X-Ray diffractogram with reflections exclusively at angular values higher than 4.0° of 2θ, preferably exclusively at angular values higher than 4.7° of 2θ, and characterized by an ordered structure which contains:
structural units having formula (a), wherein R is an organic group:

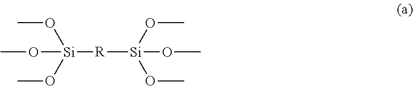

boron
one or more elements T, different from boron, selected from elements belonging to groups III B, IV B, V B, and transition metals, with a molar ratio Si/(Si+T) in said structure greater than 0.3 and lower than 1, wherein Si is the silicon contained in the structural unit having formula (a).

The units (a) are connected to each other, with the boron and with the element T by means of oxygen atoms.

Hybrid silicates and metal-silicates are particularly preferred wherein the ratio Si/(Si+T) is greater than or equal to 0.5 and lower than 1.

The elements T, trivalent or tetravalent, are in tetrahedral coordination and are inserted in the structure by means of four oxygen bridges, forming TO₄ units, as also the boron which forms BO₄ units. In particular, said units can be bound in the structure by means of these oxygen bridges, not only with structural units of type (a), but also with each other. T is preferably an element selected from Si, Al, Fe, Ti, P, Ge, Ga or a mixture thereof. T is even more preferably silicon, aluminium, iron or mixtures thereof; according to a particularly preferred aspect, T is aluminium.

As the ECS prepared by means of the process of the present invention contain boron and one or more elements T which can be trivalent, in tetrahedral coordination, the structure of the hybrid silicates and metal-silicates of the present invention will also contain cations Me that neutralize the corresponding negative charges, for example cations of alkaline, alkaline-earth metals, cations of lanthanides or mixtures thereof.

The process of the present invention is even more preferably suitable for preparing ECS hybrid silicates and metal-silicates characterized by the following formula (b):

SiO_{1.5}.xYO₂.y/nMe.zC (b)

wherein Si is the silicon contained in the structural unit (a)
Y is boron and at least one element T, different from boron, selected from elements belonging to groups IIIB, IVB, VB, and transition metals,
Me is at least one cation having a valence n,
C is carbon,
x is greater than 0 and less than or equal to 2.3, and preferably greater than 0 and less than or equal to 1,
y is greater than 0 and less than or equal to 2.3, and preferably greater than 0 and less than or equal to 1,
n is the valence of the cation Me
z ranges from 0.5 to 10.

In all the silicates and metal-silicates obtained with the process of the present invention, the molar ratio T/B is preferably greater than 0 and less than 10,000, and even more preferably varies within the range of 5-1,000. If there are more elements T, said molar ratio T/B corresponds to the ratio between the sum of the moles of said elements T and the moles of B.

The organic group R contained in the structural unit (a) can be a hydrocarbon group with a number of carbon atoms ≦20. Said hydrocarbon group can be aliphatic or aromatic, and can also be substituted with groups containing heteroatoms. The aliphatic groups can be linear or branched, and can either be saturated or unsaturated. R is preferably selected from the following groups:

—CH₂—, —CH₂CH₂—, —C₃H₆— linear or branched, —C₄H₈— linear or branched, —C₆H₄—, —CH₂—(C₆H₄)—CH₂—, —C₂H₄—(C₆H₄)—C₂H₄—, —(C₆H₄)—(C₆H₄)—, —CH₂—(C₆H₄—(C₆H₄)—CH₂—, —C₂H₄—(C₆H₄)—(C₆H₄)—C₂H₄—, —CH═CH—, —CH═CH—CH₂—, —CH₂—CH═CH—CH₂—.

In step (1) of the preparation process of the present invention, in addition to the hydroxide of the metal Me, one or more salts of metal Me can be present. The mixture of step (1) is prepared by mixing the reagents in the following proportions, expressed as molar ratios:

Si/(Si+T) is greater than 0.3 and less than 1, and is preferably greater than or equal to 0.5 and less than 1

Si/B=1-50

Me/Si=0.11-5

OH⁻/Si=0.05-2

H₂O/Si<100

wherein Si is always the silicon contained in the disilane having formula (c), and T and Me have the meanings described above. OH⁻ is calculated as the difference between the moles of Me(OH)ₙ added, multiplied by n and the moles of H⁺ added are in the form of H₃BO₃, considering three moles of H⁺ per mole of H₃BO₃.

The mixture of step (1) is even more preferably prepared by mixing the reagents in the following proportions, expressed as molar ratios:

Si/(Si+T) is greater than or equal to 0.5 and less than 1

Si/B=1-20

Me/Si=0.20-5

OH⁻/Si=0.05-2

H₂O/Si<100

wherein Si is always the silicon contained in the disilane having formula (c), and T and Me have the meanings described above.

The disilanes used in the preparation of the hybrid silicates and metal-silicates of the present invention have the following formula (c)

X₃Si—R—SiX₃ (c)

wherein R is an organic group and X is a substituent which can be hydrolyzed.

In accordance with what is specified above, R can be a hydrocarbon group with a number of carbon atoms less than or equal to 20. Said hydrocarbon group can be aliphatic or aromatic, and can also be substituted with groups containing heteroatoms. The aliphatic groups can be linear or branched, and can either be saturated or unsaturated. R is preferably selected from the following groups:

—CH₂—, —CH₂CH₂—, —C₃H₆— linear or branched, —C₄H₈— linear or branched, —C₆H₄—, —CH₂—(C₆H₄)—CH₂—, —C₂H₂—(C₆H₄)—C₂H₄—, —(C₆H₄)—(C₆H₄)—, —CH₂—(C₆H₄)—(C₆H₄)—CH₂—, —C₂H₄—(C₆H₄)—(C₆H₄)—C₂H₄—, —CH═CH—, —CH═CH—CH₂—, —CH₂—CH═CH—CH₂—, —C₁₀H₈—.

X can be an alkoxide group having the formula —OCₘH₂ₘ₊₁ wherein m is an integer selected from 1, 2, 3 or 4, or it can be a halogen selected from chlorine, bromine, fluorine and iodine. X is preferably an alkoxide group.

Compounds having formula (c) preferably used are:

(CH₃O)₃Si—CH₂—Si(OCH₃)₃

(CH₃CH₂O)₃Si—CH₂—Si(OCH₂CH₃)₃

(CH₃O)₃Si—CH₂CH₂—Si(OCH₃)₃

(CH₃CH₂O)₃Si—CH₂CH₂—Si(OCH₂CH₃)₃

(CH₃O)₃Si—C₆H₄—Si(OCH₃)₃

(CH₃CH₂O)₃Si—C₆H₄—Si(OCH₂CH₃)₃

(CH₃O)₃Si—CH₂—C₆H₄—CH₂—Si(OCH₃)₃

(CH₃CH₂O)₃Si—CH₂—C₆H₄—CH₂—Si(OCH₂CH₃)₃

(CH₃O)₃Si—C₆H₄—C₆H₄—Si(OCH₃)₃

(CH₃CH₂O)₃Si—C₆H₄—C₆H₄—Si(OCH₂CH₃)₃

(CH₃O)₃Si—CH₂—C₆H₄—C₆H₄—CH₂—Si(OCH₃)₃

(CH₃CH₂O)₃Si—CH₂—C₆H₄—C₆H₄—CH₂—Si(OCH₂CH₃)₃

(CH₃O)₃Si—C₁₀H₈—Si(OCH₃)₃

(CH₃CH₂O)₃Si—C₁₀H₈—Si(OCH₂CH₃)₃.

In the case of hybrid metal-silicates containing, in addition to boron, one or more elements of the type T, the reaction mixture will contain a source of each of said elements.

A preferred aspect of the process of the present invention is to prepare organic-inorganic silicates and metal-silicates called ECS-1, ECS-2, ECS-3, ECS-4, ECS-5, ECS-6, ECS-7: these particular silicates and metal-silicates, their porosity characteristics and main X-ray diffraction peaks are described in WO 2008/017513. With the process of the present invention, said ECS-1, ECS-2, ECS-3, ECS-4, ECS-5, ECS-6, ECS-7 can be prepared with an improved crystallinity and purity: the ECS thus obtained will contain boron in the structure and at least one element T, wherein T is different from boron and has the meanings defined above, and is preferably aluminium.

The compositions of reagent mixtures and disilanes that are preferably used for preparing in particular each of the organic-inorganic metal-silicates called ECS-1, ECS-2, ECS-3, ECS-4, ECS-5, ECS-6, ECS-7, wherein said ECS contain boron in the structure and at least one element T, are all those described in WO 2008/017513: according to the present invention, boric acid is added to said specific reagent mixtures, using specific disilanes, in such a quantity that the Si/B ratio varies within the range of 1 to 50, preferably from 1 to 20.

In particular, preferably for the preparation of ECS-1, ECS-2, ECS-3 and ECS-4, 1,4bis-(triethoxy-silyl)benzene is used as disilane, for ECS-5 4,4′bis(triethoxy-silyl)1,1′biphenyl is used, for ECS-6 1,4bis(triethoxy-silyl ethyl)benzene is used, for ECS-7 1,3 bis(trimethoxy silyl)propane is used.

The sources of the element T, wherein T has the meanings described above, and preferably can be Si, Al, Fe, Ti, P, Ge, Ga or a mixture thereof, can be the corresponding soluble salts or alkoxides. In particular, when T is silicon, sources that can be conveniently used are tetra-alkylorthosilicate, sodium silicate, colloidal silica; when T is aluminium, sources that can be conveniently used are: aluminium isopropylate, aluminium sulfate, aluminium nitrate or NaAlO₂; when T is iron, sources that can be conveniently used are iron ethoxide, iron nitrate, iron sulfate.

The hydroxide of the alkaline metal is preferably sodium hydroxide and/or potassium hydroxide.

In step (2) of the process of the present invention, the mixture is kept in an autoclave, under hydrothermal conditions, at autogenous pressure, and possibly under stirring, preferably at a temperature ranging from 70 to 180° C., even more preferably from 80 to 150° C., for a time ranging from 1 to 50 days.

At the end of the reaction, the solid phase is separated from the mother mixture by means of conventional techniques, for example filtration, washed with demineralized water and subjected to drying, preferably effected at a temperature ranging from 50 to 80° C., for a time sufficient for eliminating the water completely or substantially completely, preferably ranging from 2 to 24 hours.

The materials thus obtained can be subjected to ion exchange treatment according to the conventional methods, to obtain, for example, the corresponding acid form or exchanged with other metals Me, for example alkaline, alkaline-earth metals or lanthanides.

By adding boric acid in the first step of the preparation, in accordance with the invention, in addition to significantly increasing the reaction kinetics, obtaining ECS silicates with an improved crystallinity and purity, containing boron and at least one element T, it is also unexpectedly possible to obtain new ECS phases, i.e. new ECS characterized by the relative X-ray diffractograms.

Said new hybrid silicates and metal silicates are called ECS-13 and ECS-14 and contain boron in the structure together with one or more metals T, different from boron, selected from elements belonging to groups IIIB, IVB, VB, and transition metals. T is preferably aluminium.

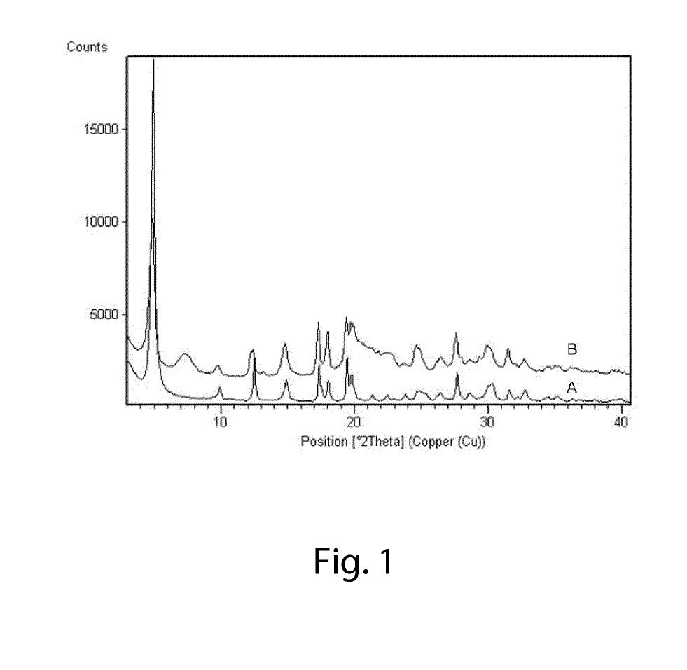

In particular, the silicates and metal silicates ECS-13 are crystalline and are characterized by a powder X-ray diffraction pattern, containing the main reflections indicated in Table 1 and FIG. 1:

TABLE 1

| | Pos. | d-spacing | Rel. Int. | FWHM |
|---|---|---|---|---|
| | [°2Th.] | [Å] | [%] | [°2Th.] |
| 1 | 5.7 | 15.6 | 100 | 0.16 |
| 2 | 10.3 | 8.6 | 1 | 0.16 |
| 3 | 11.4 | 7.8 | 10 | 0.2 |
| 4 | 12.2 | 7.2 | 27 | 0.1 |
| 5 | 13.5 | 6.6 | 10 | 0.13 |
| 6 | 16.7 | 5.3 | 2 | 0.1 |
| 7 | 17.1 | 5.2 | 19 | 0.13 |
| 8 | 17.3 | 5.1 | 23 | 0.1 |
| 9 | 18.2 | 4.9 | 22 | 0.15 |
| 10 | 19.6 | 4.5 | 3 | 0.13 |
| 11 | 20.2 | 4.4 | 8 | 0.11 |
| 12 | 20.8 | 4.3 | 2 | 0.06 |
| 13 | 21.1 | 4.2 | 2 | 0.16 |
| 14 | 22.5 | 3.9 | 18 | 0.16 |
| 15 | 22.9 | 3.9 | 3 | 0.06 |
| 16 | 24.6 | 3.6 | 6 | 0.11 |
| 17 | 24.7 | 3.6 | 5 | 0.08 |
| 18 | 26.0 | 3.4 | 14 | 0.2 |
| 19 | 26.7 | 3.3 | 3 | 0.1 |
| 20 | 27.1 | 3.3 | 2 | 0.1 |
| 21 | 27.5 | 3.2 | 16 | 0.15 |
| 22 | 28.1 | 3.2 | 6 | 0.11 |
| 23 | 28.6 | 3.1 | 15 | 0.14 |
| 24 | 28.7 | 3.1 | 15 | 0.08 |
| 25 | 29.9 | 3.0 | 22 | 0.2 |
| 26 | 31.2 | 2.9 | 3 | 0.16 |
| 27 | 31.6 | 2.8 | 7 | 0.18 |
| 28 | 32.0 | 2.8 | 4 | 0.1 |
| 29 | 32.6 | 2.7 | 13 | 0.16 |
| 30 | 32.6 | 2.7 | 10 | 0.06 |
| 31 | 33.5 | 2.7 | 6 | 0.16 |
| 32 | 34.8 | 2.6 | 5 | 0.53 |

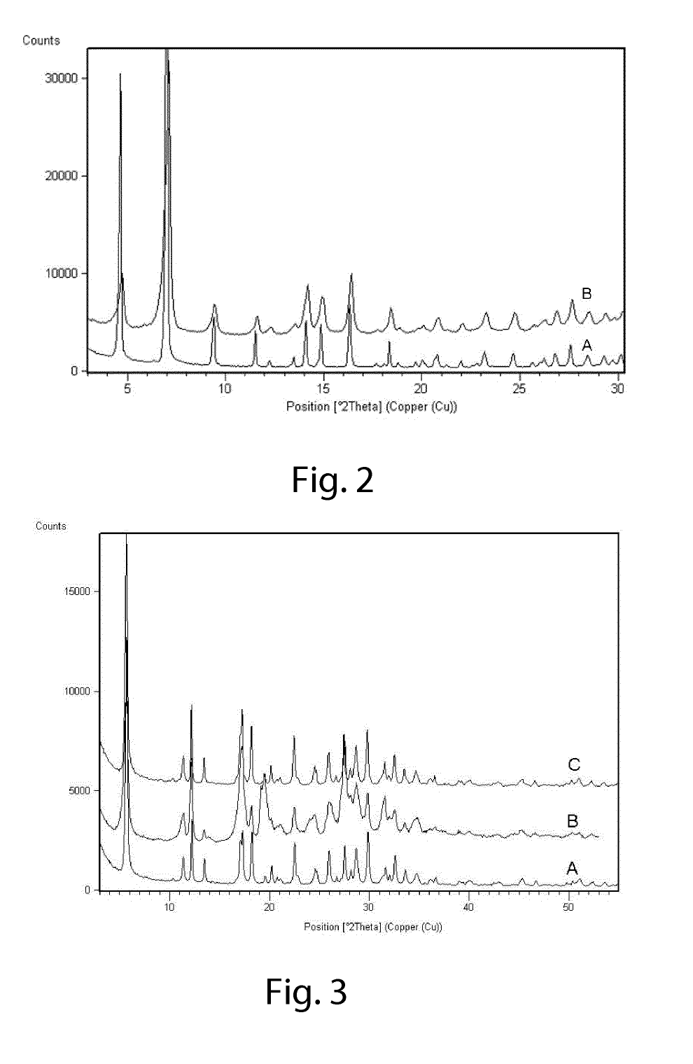

The silicates and metal silicates ECS-14 are microporous, crystalline and are characterized by a powder X-ray diffraction pattern, containing the main reflections indicated in Table 2 and FIG. 2:

TABLE 2

| | Pos. | d-spacing | Rel. Int. | FWHM |
|---|---|---|---|---|
| | [°2Th.] | [Å] | [%] | [°2Th.] |
| 1 | 6.5 | 13.6 | 68 | 0.15 |
| 2 | 7.2 | 2.3 | 100 | 0.08 |
| 3 | 9.7 | 9.1 | 3 | 0.15 |
| 4 | 12.5 | 7.1 | 17 | 0.08 |
| 5 | 13.0 | 6.8 | 35 | 0.18 |
| 6 | 14.4 | 6.1 | 5 | 0.05 |
| 7 | 14.9 | 6.0 | 10 | 0.20 |
| 8 | 19.1 | 4.7 | 19 | 0.10 |
| 9 | 19.4 | 4.6 | 42 | 0.12 |
| 10 | 20.2 | 4.4 | 2 | 0.12 |
| 11 | 20.9 | 4.3 | 5 | 0.07 |
| 12 | 21.5 | 4.1 | 17 | 0.15 |
| 13 | 23.1 | 3.8 | 4 | 0.10 |
| 14 | 25.1 | 3.6 | 34 | 0.12 |
| 15 | 25.9 | 3.4 | 10 | 0.10 |
| 16 | 26.1 | 3.4 | 19 | 0.12 |
| 17 | 26.9 | 3.3 | 4 | 0.07 |
| 18 | 27.4 | 3.3 | 2 | 0.20 |
| 19 | 27.9 | 3.2 | 4 | 0.10 |
| 20 | 28.4 | 3.1 | 10 | 0.12 |
| 21 | 29.0 | 3.1 | 8 | 0.15 |
| 22 | 30.9 | 2.9 | 6 | 0.20 |
| 23 | 31.9 | 2.8 | 11 | 0.12 |
| 24 | 32.4 | 2.8 | 4 | 0.10 |
| 25 | 32.8 | 2.7 | 4 | 0.17 |
| 26 | 33.3 | 2.7 | 19 | 0.07 |
| 27 | 34.0 | 2.6 | 3 | 0.13 |
| 28 | 35.3 | 2.5 | 4 | 0.17 |
| 29 | 35.9 | 2.5 | 6 | 0.12 |
| 30 | 37.9 | 2.4 | 2 | 0.13 |
| 31 | 43.0 | 2.1 | 2 | 0.17 |
| 32 | 47.6 | 1.9 | 4 | 0.20 |

The powder X-ray diffractograms indicated above of the materials ECS-13 and ECS-14 were all registered by means of a vertical goniometer equipped with an electronic pulse counting system and using radiation CuKα (γ=1.54178 Å). ²⁹Si-MAS-NMR analysis of the hybrid metal-silicates of the present invention ECS-13 and ECS-14 allows the presence of Si—C bonds to be revealed. It is known, in fact, that in ²⁹Si-MAS-NMR spectroscopy, the chemical shift of sites of the type Si(OT)₄ (wherein T=Si or Al) ranges from −90 to −120 ppm (G. Engelhardt, D. Michel, “High-Resolution Solid-State NMR of Silicates and Zeolites”, Wiley, New York, 1987, pp. 148-149), whereas the chemical shift of sites of the type C—Si(OT)₃, i.e. silicon atoms bound to a carbon atom, has an absolute value lower than −90 ppm, ranging for example from −50 to −90 ppm (S. Inagaki, S. Guan, T. Ohsuna, 0. Terasaki, Nature, Vol. 416, 21 Mar. 2002, page 304). In accordance with this, the organic-inorganic hybrid metal-silicates ECS-13 and ECS-14 of the present invention prepared using disilanes as silicon source, on ²⁹Si-MAS-NMR analysis, show signals whose chemical shift drops to absolute values lower than −90 ppm, in particular from −40 to −90 ppm, preferably from −50 to −90 ppm.

Said ECS-13 and ECS-14 are new and are a further object of the invention.

For preparing the materials of the ECS-13 type, the following molar ratios are preferably used:

Si/(Si+T) is greater than or equal to 0.5 and less than 1

Si/B=1-20

Me⁺/Si=0.20-5

OH⁻/Si=0.05-2

H₂O/Si less than 100,

wherein the disilane is preferably 2,6-bis-(triethoxy-silyl)-naphthalene.

For materials of the ECS-14 type, the following molar ratios are preferably used:

Si/(Si+T) is greater than or equal to 0.5 and less than 1

Si/B=1-20

Me⁺/Si=0.20-5

OH⁻/Si=0.20-2

H₂O/Si less than 100,

wherein the disilane is preferably 1,4-bis-(triethoxy-silyl)benzene.

The materials of the present invention can be subjected to a shaping treatment, binding or thin-layer deposition according to the techniques described in literature.

All the silicates and metal-silicates obtained with the process of the present invention of the ECS type, containing B and additionally at least one element T different from boron, selected from elements belonging to groups IIIB, IVB, VB, and transition metals, therefore having a molar ratio Si/(Si+T) higher than 0.3 and lower than 1, represent a selection, are new and are an object of the present invention, particularly metal-silicates characterized by the following formula (b):

SiO_{1.5}.xYO₂.y/nMe.zC (b)

wherein Si is the silicon contained in the structural unit (a)
Y is boron and at least one element T, different from boron, selected from elements belonging to groups IIIB, IVB, VB, and transition metals, Me is at least one cation having a valence n, C is carbon,
x is greater than 0 and less than or equal to 2.3, and preferably greater than 0 and less than or equal to 1,
y is greater than 0 and less than or equal to 2.3, and preferably greater than 0 and less than or equal to 1,
n is the valence of the cation Me
z ranges from 0.5 to 10.

Organic-inorganic silicates and metal-silicates of the type ECS-1, ECS-2, ECS-3, ECS-4, ECS-5, ECS-6, ECS-containing B and at least one element T different from boron, selected from elements belonging to groups IIIB, IVB, VB, and transition metals, also represent a particular selection, are new and object of the present invention. The materials prepared with the process of the present invention can be applied as molecular sieves, adsorbents, in the field of catalysis, in the field of electronics, in the field of sensors, in the field of nano-technologies.

The following examples are provided for a better understanding of the present invention without limiting its scope.

### EXAMPLE 1

### Synthesis of ECS-5 in the Presence of H₃BO₃

4.20 g of NaOH and 1.81 g of H₃BO₃ are dissolved in 12.15 g of demineralized water. 2.77 g of NaAlO₂ (54% by weight of Al₂O₃) are added, under vigorous stirring, to the limpid solution thus obtained, until a limpid or slightly gelatinous solution is obtained. 8.08 g of 4,4′bis-(triethoxy-silyl)1,1′biphenyl are finally added to the reaction environment. The mixture thus obtained has the following composition expressed as molar ratios:

Si/Al₂O₃=2.3

Si/(Si+Al)=0.53

Si/B=1.15

Na/Si=3.98

OH⁻/Si=0.50

H₂O/SiO₂=20

wherein Si is silicon deriving from 4,4′bis-(triethoxy-silyl)1,1′biphenyl, Na derives from sodium aluminate and soda, OH⁻ is calculated as the difference between the moles of NaOH added and the moles of H⁺ added in the form of H₃BO₃ (three moles of H⁺ per moles of H₃BO₃. The sample is charged into an inox steel autoclave subjected to an oscillating movement in an oven heated to 100° C. for 4 days. At the end of the treatment, the autoclave is cooled, the suspension contained therein is filtered, the solid is washed with demineralized water and dried at 60° C. for about two hours. Upon chemical analysis, the washed and dried sample has the following molar composition:
Si. 0.75 Al. 0.05 B. 0.73 Na. 5.9 C. 3.1 O

The diffractogram indicated in FIG. 1, line A, registered by means of a vertical goniometer equipped with an electronic pulse counting system and using radiation CuKα (γ=1.54178 Å), reveals the formation of ECS-5 well crystallized. Table 1 indicates the list of the main reflections of the ECS-5 phase:

TABLE 1

| | Pos. | d-spacing | Rel. Int. | FWHM |
|---|---|---|---|---|
| | [°2Th.] | [Å] | [%] | [°2Th.] |
| 1 | 5.0 | 17.8 | 100 | 0.1 |
| 2 | 9.9 | 8.9 | 4 | 0.13 |
| 3 | 12.5 | 7.1 | 14 | 0.08 |
| 4 | 14.9 | 6.0 | 6 | 0.12 |
| 5 | 17.4 | 5.1 | 12 | 0.08 |
| 6 | 18.1 | 4.9 | 7 | 0.08 |
| 7 | 19.5 | 4.6 | 14 | 0.09 |
| 8 | 19.8 | 4.5 | 9 | 0.09 |
| 9 | 21.3 | 4.2 | 2 | 0.14 |
| 10 | 22.5 | 4.0 | 2 | 0.12 |
| 11 | 23.8 | 3.7 | 2 | 0.06 |
| 12 | 24.7 | 3.6 | 2 | 0.12 |
| 13 | 25.0 | 3.6 | 3 | 0.09 |
| 14 | 25.4 | 3.5 | 2 | 0.12 |
| 15 | 26.4 | 3.4 | 2 | 0.05 |
| 16 | 27.7 | 3.2 | 8 | 0.08 |
| 17 | 28.6 | 3.1 | 3 | 0.06 |
| 18 | 30.0 | 3.0 | 4 | 0.14 |
| 19 | 30.4 | 2.9 | 5 | 0.06 |
| 20 | 31.5 | 2.8 | 3 | 0.05 |
| 21 | 32.8 | 2.7 | 3 | 0.07 |

### EXAMPLE 2

### Comparative

A sample of ECS-5 is prepared without boric acid, in accordance with WO2008/017513. 0.56 g of NaOH are dissolved in 5.56 g of demineralized water. 1.15 g of NaAlO₂ (54% by weight of Al₂O₃) are added, under vigorous stirring, to the limpid solution thus obtained, until a limpid or slightly gelatinous solution is obtained. 6.72 g of 4,4′bis-(triethoxy-silyl)1,1′biphenyl are finally added to the reaction environment. The mixture thus obtained has the following composition expressed as molar ratios:

Si/Al₂O₃=4.6

Si/(Si+Al)=0.70

Na/Si=0.93

OH—/Si=0.50

H₂O/SiO₂=11

wherein Si is silicon deriving from 4,4′bis-(triethoxy-silyl)1,1′biphenyl, Na derives from sodium aluminate and soda.

The sample is charged into a stainless steel autoclave subjected to an oscillating movement in an oven heated to 100° C. for 14 days. At the end of the treatment, the autoclave is cooled, the suspension contained therein is filtered, the solid is washed with demineralized water and dried at 60° C. for about two hours. The diffractogram, indicated in FIG. 1, line B, shows that the ECS-5 phase is not pure as it is accompanied by a second phase with an extremely forced micro-crystallinity.

On comparing the same XRD spectrum with that of the product according to Example 1, it can be observed that the sample prepared in the presence of boric acid has a higher crystallinity degree, even if the crystallization time is shorter (4 days vs 14 days). The presence of boric acid in the synthesis therefore favours the crystallization kinetics of the ECS-phase and also its crystallinity.

### EXAMPLE 3

### Synthesis of ECS-7 in the Presence of Boric Acid

4.60 g of NaOH and 2.06 g of H₃BO₃ are dissolved in 13.76 g of demineralized water. The limpid solution thus obtained is heated to about 60° C. and 3.14 g of NaAlO₂ (54% by weight of Al₂O₃) are added, under vigorous stirring, until a limpid or slightly gelatinous solution is obtained. The solution is brought back to room temperature and 5.44 g of 1,3-bis-(trimethoxy-silyl)propane are finally added to the reaction environment. The mixture thus obtained has the following composition expressed as molar ratios:

Si/Al₂O₃=2.3

Si/(Si+Al)=0.53

Si/B=1.15

Na/Si=3.9

OH⁻/Si=0.40

H₂O/SiO₂=20

wherein Si is silicon deriving from 1,3-bis-(trimethoxy-silyl)propane, Na derives from sodium aluminate and soda, OH⁻ is calculated as the difference between the moles of NaOH added and the moles of H⁺ added in the form of H₃BO₃ (three moles of H⁺ per moles of H₃BO₃). The sample is charged into a stainless steel autoclave subjected to an oscillating movement in an oven heated to 100° C. for 7 days. At the end of the treatment, the autoclave is cooled, the suspension contained therein is filtered, the solid is washed with demineralized water and dried at 60° C. for about two hours. The diffractogram indicated in FIG. 2, line A, registered by means of a vertical goniometer equipped with an electronic pulse counting system and using radiation CuKα (γ=1.54178 Å), reveals the formation of extremely crystalline ECS-7. Table 2 indicates the list of the main reflections of ECS-7:

TABLE 2

| | Pos. | d-spacing | Rel. Int. | FWHM |
|---|---|---|---|---|
| | [°2Th.] | [Å] | [%] | [°2Th.] |
| 1 | 4.7 | 18.9 | 32 | 0.08 |
| 2 | 7.0 | 12.6 | 100 | 0.08 |
| 3 | 9.4 | 9.4 | 5 | 0.08 |
| 4 | 11.5 | 7.7 | 4 | 0.08 |
| 5 | 12.3 | 7.2 | 1 | 0.1 |
| 6 | 13.5 | 6.6 | 1 | 0.08 |
| 7 | 14.1 | 6.3 | 5 | 0.1 |
| 8 | 14.9 | 6.0 | 5 | 0.08 |
| 9 | 16.3 | 5.4 | 7 | 0.12 |
| 10 | 18.4 | 4.8 | 3 | 0.08 |
| 11 | 19.7 | 4.5 | 1 | 0.1 |
| 12 | 20.0 | 4.4 | 1 | 0.12 |
| 13 | 20.8 | 4.3 | 1 | 0.1 |
| 14 | 22.0 | 4.0 | 1 | 0.1 |
| 15 | 23.1 | 3.8 | 1 | 0.08 |
| 16 | 24.6 | 3.6 | 2 | 0.16 |
| 17 | 25.6 | 3.5 | 0 | 0.1 |
| 18 | 26.0 | 3.4 | 1 | 0.16 |
| 19 | 26.2 | 3.4 | 1 | 0.14 |
| 20 | 26.8 | 3.3 | 1 | 0.2 |
| 21 | 27.6 | 3.2 | 3 | 0.16 |
| 22 | 28.4 | 3.1 | 1 | 0.18 |
| 23 | 29.3 | 3.0 | 1 | 0.18 |
| 24 | 29.7 | 3.0 | 1 | 0.2 |
| 25 | 30.1 | 3.0 | 1 | 0.2 |
| 26 | 33.0 | 2.7 | 2 | 0.14 |

### EXAMPLE 4

### Comparative

A sample of ECS-7 is prepared without boric acid, in accordance with WO2008/017513. 0.20 g of NaOH are dissolved in 6.47 g of demineralized water. The limpid solution thus obtained is heated to about 60° C. and 2.68 g of NaAlO₂ (54% by weight of Al₂O₃) are added, under vigorous stirring, until a limpid or slightly gelatinous solution is obtained. The solution is brought back to room temperature and 4.65 g of 1,3-bis-(trimethoxy-silyl)propane are finally added to the reaction environment. The mixture thus obtained has the following composition expressed as molar ratios:

Si/Al₂O₃=2.3

Si/(Si+Al)=0.53

OH⁻/Si=0.15

Na/Si=1.02

H₂O/Si=11

wherein Si is silicon deriving from 1,3-bis-(trimethoxy-silyl)propane, Na derives from sodium aluminate and soda.

The sample is charged into a stainless steel autoclave subjected to an oscillating movement in an oven heated to 100° C. for 7 days. At the end of the treatment, the autoclave is cooled, the suspension contained therein is filtered, the solid is washed with demineralized water and dried at 60° C. for about two hours. The powder X-ray diffraction pattern, registered by means of a vertical goniometer equipped with an electronic pulse counting system and using radiation CuKα (γ=1.54178 Å), is indicated in FIG. 2, line B, and shows that the sample ECS-7 is crystalline. On comparing the same XRD spectrum with that of the sample according to Example 3, it can be observed that the latter, prepared in the presence of boric acid, has much narrower reflections and the absence of even weak incoherent scattering phenomena associated with the presence of amorphous material. The product obtained in the presence of boric acid therefore has a higher crystallinity and more regular crystals, with larger dimensions than that synthesized in the absence of boric acid. The growth of the crystals, with the other synthesis conditions remaining identical, is linked to the prolonging of the crystallization time, for which, as the two products are obtained after 7 days of hydrothermal treatment, the addition of boric acid proves to favour the crystallization kinetics of the ECS-7 phase.

### EXAMPLE 5

### Synthesis of ECS-13 in the Presence of Boric Acid

2.42 g of NaOH and 0.70 g of H₃BO₃ are dissolved in 18.87 g of demineralized water. The limpid solution thus obtained is heated to about 60° C. and 1.08 g of NaAlO₂ (54% by weight of Al₂O₃) are added, under vigorous stirring, until a limpid or slightly gelatinous solution is obtained. The solution is brought back to room temperature and 5.93 g of 2,6-bis-(triethoxy-silyl)naphthalene are finally added to the reaction environment. The mixture thus obtained has the following composition expressed as molar ratios:

Si/Al₂O₃=4.6

Si/(Si+Al)=0.70

Si/B=2.3

Na/Si=2.7

OH⁻/Si=1.0

H₂O/Si=40

wherein Si is silicon deriving from 2,6-bis-(triethoxy-silyl)naphthalene, Na derives from sodium aluminate and soda, OH⁻is calculated as the difference between the moles of NaOH added and the moles of H⁺ added in the form of H₃BO₃ (three moles of H⁺ per moles of H₃BO₃). The sample is charged into a stainless steel autoclave subjected to an oscillating movement in an oven heated to 100° C. for 5 days. At the end of the treatment, the autoclave is cooled, the suspension contained therein is filtered, the solid is washed with demineralized water and dried at 60° C. for about two hours. The diffractogram indicated in FIG. 3, line A, registered by means of a vertical goniometer equipped with an electronic pulse counting system and using radiation CuKα (γ=1.54178 Å), reveals the formation of extremely crystalline ECS-13. Table 3 indicates the list of the main reflections present in XRD spectrum of ECS-13:

TABLE 3

| | Pos. | d-spacing | Rel. Int. | FWHM |
|---|---|---|---|---|
| | [°2Th.] | [Å] | [%] | [°2Th.] |
| 1 | 5.7 | 15.6 | 100 | 0.16 |
| 2 | 10.3 | 8.6 | 1 | 0.16 |
| 3 | 11.4 | 7.8 | 10 | 0.2 |
| 4 | 12.2 | 7.2 | 27 | 0.1 |
| 5 | 13.5 | 6.6 | 10 | 0.13 |
| 6 | 16.7 | 5.3 | 2 | 0.1 |
| 7 | 17.1 | 5.2 | 19 | 0.13 |
| 8 | 17.3 | 5.1 | 23 | 0.1 |
| 9 | 18.2 | 4.9 | 22 | 0.15 |
| 10 | 19.6 | 4.5 | 3 | 0.13 |
| 11 | 20.2 | 4.4 | 8 | 0.11 |
| 12 | 20.8 | 4.3 | 2 | 0.06 |
| 13 | 21.1 | 4.2 | 2 | 0.16 |
| 14 | 22.5 | 3.9 | 18 | 0.16 |
| 15 | 22.9 | 3.9 | 3 | 0.06 |
| 16 | 24.6 | 3.6 | 6 | 0.11 |
| 17 | 24.7 | 3.6 | 5 | 0.08 |
| 18 | 26.0 | 3.4 | 14 | 0.2 |
| 19 | 26.7 | 3.3 | 3 | 0.1 |
| 20 | 27.1 | 3.3 | 2 | 0.1 |
| 21 | 27.5 | 3.2 | 16 | 0.15 |
| 22 | 28.1 | 3.2 | 6 | 0.11 |
| 23 | 28.6 | 3.1 | 15 | 0.14 |
| 24 | 28.7 | 3.1 | 15 | 0.08 |
| 25 | 29.9 | 3.0 | 22 | 0.2 |
| 26 | 31.2 | 2.9 | 3 | 0.16 |
| 27 | 31.6 | 2.8 | 7 | 0.18 |
| 28 | 32.0 | 2.8 | 4 | 0.1 |
| 29 | 32.6 | 2.7 | 13 | 0.16 |
| 30 | 32.6 | 2.7 | 10 | 0.06 |
| 31 | 33.5 | 2.7 | 6 | 0.16 |
| 32 | 34.8 | 2.6 | 5 | 0.53 |

### EXAMPLE 6

### Comparative

1.09 g of NaOH are dissolved in 19.54 g of demineralized water. The limpid solution thus obtained is heated to about 60° C. and 2.23 g of NaAlO₂ (54% by weight of Al₂O₃) are added, under vigorous stirring, until a limpid or slightly gelatinous solution is obtained. The solution is brought back to room temperature and 6.14 g of 2,6-bis-(triethoxy-silyl)naphthalene are finally added to the reaction environment. The mixture thus obtained has the following composition, expressed as molar ratios:

Si/Al₂O₃=2.3

Si/(Si+Al)=0.53

Na/Si=1.9

OH—/Si=1.0

H2O/Si=40

wherein Si is silicon deriving from 2,6-bis-(triethoxy-silyl)-naphthalene, Na derives from sodium aluminate and soda.

The sample is subdivided into two stainless steel autoclaves, charged into an oven heated to 100° C. for 7 and 14 days, subjected to an oscillating movement. At the end of the treatment, the autoclaves are cooled, the suspension contained therein is filtered, the solid is washed with demineralized water and dried at 60° C. for about two hours. The diffractograms indicated in FIG. 3, lines B and C, relating to the samples at 7 and 14 days, respectively show that for low crystallization times the ECS-13 phase is accompanied by significant quantities of amorphous phase (responsible for the weak scattering diffused in the region 15-35° 2theta) and reflections with a significantly greater width than those present in the sample prepared in the presence of boric acid. This indicates the reduced dimension of the crystals and/or their extremely defective nature. An ECS-13 having a quality comparable, in terms of crystallinity and size of the crystals, to that obtained in Example 5, is only obtained after 14 days of crystallization, a much longer time with respect to the 5 days necessary for crystallization in the presence of boric acid. These data demonstrate the positive role of boric acid in accelerating the crystallization kinetics of the ECS-13 phase.

### EXAMPLE 7

### Synthesis of ECS-14 in the Presence of Boric Acid

3.05 g of NaOH and 1.32 g of H₃BO₃ are dissolved in 17.67 g of demineralized water. 2.02 g of NaAlO₂ (54% by weight of Al₂O₃) are added to the limpid solution thus obtained, under vigorous stirring, until a limpid or slightly gelatinous solution is obtained. 4.94 g of 1,4-bis-(triethoxy-silyl)benzene are finally added to the reaction environment. The mixture thus obtained has the following composition expressed as molar ratios:

Si/Al₂O₃=2.3

Si/(Si+Al)=0.53

Si/B=1.15

Na/Si=4.0

OH⁻/Si=0.51

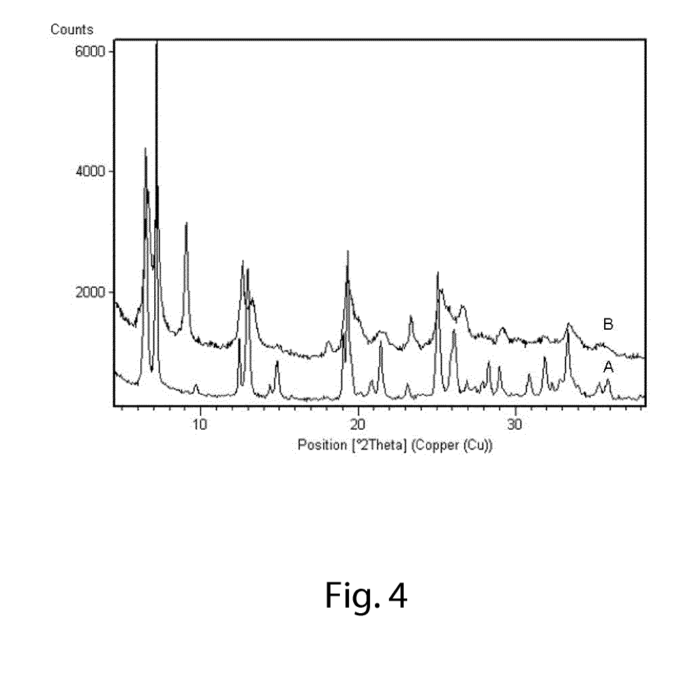

H₂O/SiO₂=40

wherein Si is silicon deriving from 1,4-bis-(triethoxy-silyl)benzene, Na derives from sodium aluminate and soda, OH⁻is calculated as the difference between the moles of NaOH added and the moles of H⁺ added in the form of H₃BO₃ (three moles of H⁺ per moles of H₃BO₃). The sample is charged into a stainless steel autoclave subjected to an oscillating movement in an oven heated to 100° C. for 7 days. At the end of the treatment, the autoclave is cooled, the suspension contained therein is filtered, the solid is washed with demineralized water and dried at 60° C. for about two hours. The diffractogram, registered by means of a vertical goniometer equipped with an electronic pulse counting system and using radiation CuKα (γ=1.54178 Å), indicated in FIG. 4, line A, reveals the formation of well-crystallized ECS-14. Table 4 indicates the list of the main reflections present in XRD spectrum of ECS-14:

TABLE 4

| | Pos. | d-spacing | Rel. Int. | FWHM |
|---|---|---|---|---|
| | [°2Th.] | [Å] | [%] | [°2Th.] |
| 1 | 6.5 | 13.6 | 68 | 0.15 |
| 2 | 7.2 | 2.3 | 100 | 0.08 |
| 3 | 9.7 | 9.1 | 3 | 0.15 |
| 4 | 12.5 | 7.1 | 17 | 0.08 |
| 5 | 13.0 | 6.8 | 35 | 0.18 |
| 6 | 14.4 | 6.1 | 5 | 0.05 |
| 7 | 14.9 | 6.0 | 10 | 0.20 |
| 8 | 19.1 | 4.7 | 19 | 0.10 |
| 9 | 19.4 | 4.6 | 42 | 0.12 |
| 10 | 20.2 | 4.4 | 2 | 0.12 |
| 11 | 20.9 | 4.3 | 5 | 0.07 |
| 12 | 21.5 | 4.1 | 17 | 0.15 |
| 13 | 23.1 | 3.8 | 4 | 0.10 |
| 14 | 25.1 | 3.6 | 34 | 0.12 |
| 15 | 25.9 | 3.4 | 10 | 0.10 |
| 16 | 26.1 | 3.4 | 19 | 0.12 |
| 17 | 26.9 | 3.3 | 4 | 0.07 |
| 18 | 27.4 | 3.3 | 2 | 0.20 |
| 19 | 27.9 | 3.2 | 4 | 0.10 |
| 20 | 28.4 | 3.1 | 10 | 0.12 |
| 21 | 29.0 | 3.1 | 8 | 0.15 |
| 22 | 30.9 | 2.9 | 6 | 0.20 |
| 23 | 31.9 | 2.8 | 11 | 0.12 |
| 24 | 32.4 | 2.8 | 4 | 0.10 |
| 25 | 32.8 | 2.7 | 4 | 0.17 |
| 26 | 33.3 | 2.7 | 19 | 0.07 |
| 27 | 34.0 | 2.6 | 3 | 0.13 |
| 28 | 35.3 | 2.5 | 4 | 0.17 |
| 29 | 35.9 | 2.5 | 6 | 0.12 |
| 30 | 37.9 | 2.4 | 2 | 0.13 |
| 31 | 43.0 | 2.1 | 2 | 0.17 |
| 32 | 47.6 | 1.9 | 4 | 0.20 |

### EXAMPLE 8

### Comparative

0.21 g of NaOH are dissolved in 3.80 g of demineralized water. 0.87 g of NaAlO₂ (54% by weight of Al₂O₃) are added to the limpid solution thus obtained, under vigorous stirring, until a limpid or slightly gelatinous solution is obtained. 2.13 g of 1,4-bis-(triethoxy-silyl)benzene are finally added to the reaction environment. The mixture thus obtained has the following composition, expressed as molar ratios:

Si/Al₂O₃=2.3

Si/(Si+Al)=0.53

Na/Si=1.4

OH⁻/Si=0.5

H₂O/SiO₂=20

wherein Si is silicon deriving from 1,4-bis-(triethoxy-silyl)benzene, Na derives from sodium aluminate and soda. The sample is charged into a stainless steel autoclave subjected to an oscillating movement in an oven heated to 100° C. for 7 days. At the end of the treatment, the autoclave is cooled, the suspension contained therein is filtered, the solid is washed with demineralized water and dried at 60° C. for about two hours. The diffractogram, registered by means of a vertical goniometer equipped with an electronic pulse counting system and using radiation CuKα (γ=1.54178 Å), indicated in FIG. 4, line B, shows that the product is only partially crystallized and that the non-identified crystalline phase(s) only incidentally present have reflections coinciding with or close to those present in the XRD spectrum of the ECS-14 phase.

1) A process for the preparation of organic-inorganic hybrid silicates and metal-silicates of the ECS type characterized by an X-Ray diffractogram with reflections exclusively at angular values higher than 4.0° of 2θ, and characterized by an ordered structure which contains:
structural units having formula (a), wherein R is an organic group: 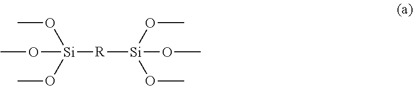
boron
one or more elements T, different from boron, selected from elements belonging to groups III B, IV B, V B, and transition metals, with a molar ratio Si/(Si+T) in said structure greater than 0.3 and lower than 1, wherein Si is the silicon contained in the structural unit having formula (a),
wherein said process comprises:
1) adding a disilane having formula (c)
X₃Si—R—SiX₃ (c)
wherein R is an organic group and X is a substituent which can be hydrolized, to an aqueous mixture containing boric acid, at least one hydroxide of at least one metal Me selected from alkaline and/or alkaline-earth metals, and one or more sources of one or more elements T, different from boron, selected from elements belonging to groups III B, IV B, V B, and transition metals,
2) maintaining the mixture under hydrothermal conditions, at autogenous pressure, for a time sufficient for forming a solid material,
3) recovering the solid and drying it.

2) The process according to claim 1, wherein the organic-inorganic hybrid silicate or metal-silicate of the ECS type has a ratio Si/(Si+T) greater than or equal to 0.5 and lower than 1.

3) The process according to claim 1 or 2, wherein the hybrid silicates and metal-silicates of the ECS type are characterized by the following formula (b):
SiO_{1.5}.xYO₂.y/nMe.zC (b)
wherein Si is the silicon contained in the structural unit (a)
Y is boron and at least one element T, different from boron, selected from elements belonging to groups III B, IV B, V B, and transition metals,
Me is at least one cation having a valence n,
C is carbon,
x is greater than 0 and less than or equal to 2.3, and preferably greater than 0 and less than or equal to 1,
y is greater than 0 and less than or equal to 2.3, and preferably greater than 0 and less than or equal to 1,
n is the valence of the cation Me
z ranges from 0.5 to 10.

4) The process according to claim 1, wherein the organic-inorganic silicates and metal-silicates are selected from ECS-1, ECS-2, ECS-3, ECS-4, ECS-5, ECS-6, ECS-7, ECS-13, ECS-14.

5) The process according to claim 1, wherein the molar ratio T/B in the organic-inorganic hybrid silicates and metal-silicates is greater than 0 and less than 10,000.

6) The process according to claim 5, wherein the ratio T/B varies within the range of 5-1,000.

7) The process according to claim 1, wherein the organic group R contained in the structural unit (a) is a hydrocarbon group with a number of carbon atoms ≦20.

8) The process according to claim 1, wherein the mixture of step (1) is prepared by mixing the reagents in the following proportions, expressed as molar ratios:
Si/(Si+T) is greater than 0.3 and less than 1, and is preferably greater than or equal to 0.5 and less than 1
Si/B=1-50
Me/Si=0.11-5
OH⁻/Si=0.05-2
H₂O/Si<100
wherein Si is always the silicon contained in the disilane having formula (c).

9) The process according to claim 7, wherein the mixture of step (1) is prepared by mixing the reagents in the following proportions, expressed as molar ratios:
Si/(Si+T) is greater than or equal to 0.5 and less than 1
Si/B=1-20
Me/Si=0.20-5
OH⁻/Si=0.05-2
H₂O/Si<100
wherein Si is always the silicon contained in the disilane having formula (c).

10) The process according to claim 1, wherein the organic-inorganic silicates and metal-silicates are of the type ECS-13, wherein in step (1) the following molar ratios are used:
Si/(Si+T) is greater than or equal to 0.5 and less than 1
Si/B=1-20
Me⁺/Si=0.20-5
OH⁻/Si=0.05-2
H₂O/Si less than 100,
and the disilane is 2,6-bis-(triethoxy-silyl)-naphthalene.

11) The process according to claim 1, wherein the organic-inorganic silicates and metal-silicates are of the type ECS-14, wherein in step (1) the following molar ratios are used:
Si/(Si+T) is greater than or equal to 0.5 and less than 1
Si/B=1-20
Me⁺/Si=0.20-2
H₂O/Si less than 100,
and the disilane is 1,4-bis-(triethoxy-silyl)-benzene.

12) The process according to claim 1, wherein in step (1) the disilanes used have the following formula (c)
X₃Si—R—SiX₃ (c)
wherein R is an organic group and X is a substituent which can be hydrolyzed.

13) The process according to claim 1, wherein in step (2) the mixture is maintained in an autoclave, under hydrothermal conditions, at autogenous pressure, and possibly under stirring, at a temperature ranging from 70 to 180° C., for a time ranging from 1 to 50 days.

14) The process according to claim 1, wherein in step (3) the solid is separated, washed and subjected to drying.

15) Hybrid silicates and metal silicates of the ECS type, characterized by an X-ray diffractogram with reflections exclusively at angular values higher than 4.0° of 2θ, and characterized by an ordered structure which contains:
structural units having formula (a), wherein R is an organic group: 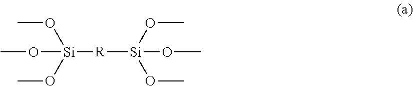
boron
one or more elements T, different from boron, selected from elements belonging to groups III B, IV B, V B, and transition metals, with a molar ratio Si/(Si+T) in said structure greater than 0.3 and lower than 1, wherein Si is the silicon contained in the structural unit having formula (a).

16) The silicates and metal silicates according to claim 15, characterized by the following formula (b):
SiO_{1.5}.xYO₂.y/nMe.zC (b)
wherein Si is the silicon contained in the structural unit (a)
Y is boron and at least one element T, different from boron, selected from elements belonging to groups III B, IV B, V B, and transition metals,
Me is at least one cation having a valence n,
C is carbon,
x is greater than 0 and less than or equal to 2.3, and preferably greater than 0 and less than or equal to 1,
y is greater than 0 and less than or equal to 2.3, and preferably greater than 0 and less than or equal to 1,
n is the valence of the cation Me
z ranges from 0.5 to 10.

17) The silicates and metal silicates according to claim 15, of the type ECS-1, ECS-2, ECS-3, ECS-4, ECS-5, ECS-6, ECS-7, containing B and at least one element T different from boron, selected from elements belonging to groups III B, IV B, V B, and transition metals.

18) Hybrid silicates and metal silicates of the type ECS-13, crystalline, containing boron in the structure and one or more elements T, selected from elements belonging to groups III B, IV B, V B, and transition metals, characterized by a powder X-ray diffraction pattern, containing the following main reflections:

| | Pos. | d-spacing | Rel. Int. | FWHM |
|---|---|---|---|---|
| | [°2Th.] | [Å] | [%] | [°2Th.] |
| 1 | 5.7 | 15.6 | 100 | 0.16 |
| 2 | 10.3 | 8.6 | 1 | 0.16 |
| 3 | 11.4 | 7.8 | 10 | 0.2 |
| 4 | 12.2 | 7.2 | 27 | 0.1 |
| 5 | 13.5 | 6.6 | 10 | 0.13 |
| 6 | 16.7 | 5.3 | 2 | 0.1 |
| 7 | 17.1 | 5.2 | 19 | 0.13 |
| 8 | 17.3 | 5.1 | 23 | 0.1 |
| 9 | 18.2 | 4.9 | 22 | 0.15 |
| 10 | 19.6 | 4.5 | 3 | 0.13 |
| 11 | 20.2 | 4.4 | 8 | 0.11 |
| 12 | 20.8 | 4.3 | 2 | 0.06 |
| 13 | 21.1 | 4.2 | 2 | 0.16 |
| 14 | 22.5 | 3.9 | 18 | 0.16 |
| 15 | 22.9 | 3.9 | 3 | 0.06 |
| 16 | 24.6 | 3.6 | 6 | 0.11 |
| 17 | 24.7 | 3.6 | 5 | 0.08 |
| 18 | 26.0 | 3.4 | 14 | 0.2 |
| 19 | 26.7 | 3.3 | 3 | 0.1 |
| 20 | 27.1 | 3.3 | 2 | 0.1 |
| 21 | 27.5 | 3.2 | 16 | 0.15 |
| 22 | 28.1 | 3.2 | 6 | 0.11 |
| 23 | 28.6 | 3.1 | 15 | 0.14 |
| 24 | 28.7 | 3.1 | 15 | 0.08 |
| 25 | 29.9 | 3.0 | 22 | 0.2 |
| 26 | 31.2 | 2.9 | 3 | 0.16 |
| 27 | 31.6 | 2.8 | 7 | 0.18 |
| 28 | 32.0 | 2.8 | 4 | 0.1 |
| 29 | 32.6 | 2.7 | 13 | 0.16 |
| 30 | 32.6 | 2.7 | 10 | 0.06 |
| 31 | 33.5 | 2.7 | 6 | 0.16 |
| 32 | 34.8 | 2.6 | 5 | 0.53 |

19) Hybrid silicates and metal silicates of the type ECS-14, microporous, crystalline, containing boron in the structure and one or more elements T, selected from elements belonging to groups III B, IV B, V B, and transition metals, characterized by a powder X-ray diffraction pattern, containing the following main reflections:

| | Pos. | d-spacing | Rel. Int. | FWHM |
|---|---|---|---|---|
| | [°2Th.] | [Å] | [%] | [°2Th.] |
| 1 | 6.5 | 13.6 | 68 | 0.15 |
| 2 | 7.2 | 2.3 | 100 | 0.08 |
| 3 | 9.7 | 9.1 | 3 | 0.15 |
| 4 | 12.5 | 7.1 | 17 | 0.08 |
| 5 | 13.0 | 6.8 | 35 | 0.18 |
| 6 | 14.4 | 6.1 | 5 | 0.05 |
| 7 | 14.9 | 6.0 | 10 | 0.20 |
| 8 | 19.1 | 4.7 | 19 | 0.10 |
| 9 | 19.4 | 4.6 | 42 | 0.12 |
| 10 | 20.2 | 4.4 | 2 | 0.12 |
| 11 | 20.9 | 4.3 | 5 | 0.07 |
| 12 | 21.5 | 4.1 | 17 | 0.15 |
| 13 | 23.1 | 3.8 | 4 | 0.10 |
| 14 | 25.1 | 3.6 | 34 | 0.12 |
| 15 | 25.9 | 3.4 | 10 | 0.10 |
| 16 | 26.1 | 3.4 | 19 | 0.12 |
| 17 | 26.9 | 3.3 | 4 | 0.07 |
| 18 | 27.4 | 3.3 | 2 | 0.20 |
| 19 | 27.9 | 3.2 | 4 | 0.10 |
| 20 | 28.4 | 3.1 | 10 | 0.12 |
| 21 | 29.0 | 3.1 | 8 | 0.15 |
| 22 | 30.9 | 2.9 | 6 | 0.20 |
| 23 | 31.9 | 2.8 | 11 | 0.12 |
| 24 | 32.4 | 2.8 | 4 | 0.10 |
| 25 | 32.8 | 2.7 | 4 | 0.17 |
| 26 | 33.3 | 2.7 | 19 | 0.07 |
| 27 | 34.0 | 2.6 | 3 | 0.13 |
| 28 | 35.3 | 2.5 | 4 | 0.17 |
| 29 | 35.9 | 2.5 | 6 | 0.12 |
| 30 | 37.9 | 2.4 | 2 | 0.13 |
| 31 | 43.0 | 2.1 | 2 | 0.17 |
| 32 | 47.6 | 1.9 | 4 | 0.20 |

20) The organic-inorganic hybrid silicates and metal silicates ECS-13 according to claim 18, which, upon ²⁹Si-MAS-NMR analysis, show signals whose chemical shift drops to absolute values lower than −90 ppm, in particular from −40 to −90 ppm.

21) Use of the silicates and metal silicates according to claim 15 as molecular sieves, adsorbants, in the field of catalysis, in the electronics field, in the field of sensors, in the field of nanotechnologies.

22) The organic-inorganic hybrid silicates and metal silicates ECS-14 according to claim 19, which, upon ²⁹Si-MAS-NMR analysis, show signals whose chemical shift drops to absolute values lower than −90 ppm, in particular from −40 to −90 ppm.
